(19) United States
(12) Patent Application Publication
(10) Pub. No.: US 2012/0185909 A1
(43) Pub. Date: Jul. 19, 2012

(54) RELAY APPARATUS FOR TRANSMITTING ANCILLARY DATA FOR A TERRESTRIAL DIGITAL TELEVISION BROADCAST, AND METHOD FOR SAME

(75) Inventors: Jae-Hyun Seo, Daejeon (KR); Sung-Ik Park, Daejeon (KR); Ho-Min Eum, Daejeon (KR); Hyoungsoo Lmi, Daejeon (KR); Heung-Mook Kim, Daejeon (KR)

(73) Assignee: Electronics and Telecommunications Research Instit, Daejeon (KR)

(21) Appl. No.: 13/498,697

(22) PCT Filed: Sep. 8, 2010
(86) PCT No.: PCT/KR10/06078

§ 371 Date: Mar. 28, 2012

(30) Foreign Application Priority Data
Oct. 5, 2009 (KR) 10-2009-0094301
May 27, 2010 (KR) 10-2010-0049581

(51) Int. Cl. H04N 21/61

(52) U.S. Cl. 725/149

(57) ABSTRACT

The present invention relates to a relay apparatus for transmitting ancillary data and to a method for same, and particularly, to a relay apparatus for transmitting ancillary data for a terrestrial digital television broadcast and to a method for same. The apparatus according to one embodiment of the present invention comprises: a relay apparatus for relaying a digital broadcast (DTV) signal containing ancillary data; a receiving and processing unit for receiving the ancillary data and DTV signal via a receiving antenna, down-converting the received signal into an intermediate frequency (IF) signal, and demodulating the IF signal; an equalizing unit for removing noise and a multipath signal from the signal output from the receiving and processing unit, and outputting the resulting signal; an ancillary data extraction unit for extracting the ancillary data from the signal output from the equalizing unit, and outputting the extracted ancillary data; an adder for adding the output from the ancillary data extraction unit to the DTV signal output from the equalization unit; and a transmitting and processing unit for modulating the output from the adder, up-converting the modulated output into a transmitting RF band, amplifying the transmitting power, and transmitting the amplified power via a transmitting antenna.

### TECHNICAL FIELD

Exemplary embodiments of the present invention relate to a repeating apparatus and a repeating method for transmitting additional data; and, more particularly, to a repeating apparatus and a repeating method for transmitting additional data of terrestrial digital television broadcasting.

### BACKGROUND ART

Recently, in television broadcasting, transition from analog-to-digital broadcasting is in progress. The television broadcasting is provided using various methods such as using general sky wave, using a wired cable, and using a terrestrial broadcasting service and satellite. As the television broadcasting is provided using various methods, television in hand is possible.

Such television broadcasting is necessarily transmitted through a repeater except for the case in which broadcasting service data is directly received through a wired cable and a satellite. This is because the same broadcasting data is required to be transmitted in a wide range through the television broadcasting.

Hereinafter, methods for transmitting such broadcasting will be described with reference to the accompanying drawings.

FIG. 1 is a configuration diagram of an RF amplification repeating apparatus for repeating a television broadcasting signal.

Referring to FIG. 1, a receiver antenna 101 and an RF reception unit 102 receive an RF signal transmitted from a broadcasting station or another repeater (hereinafter, referred to as “a main transmitter”). The signal received in the RF reception unit 102 is an RF signal of a predetermined band for the reception of a broadcasting signal. However, actually, signals of a wide band are received in the RF reception unit 102 as well as the signal of the band only for the broadcasting signal. Therefore, an RF bandpass filter 103 filters only a signal of a desired band, that is, the broadcasting signal. The broadcasting signal filtered by the RF bandpass filter 103 is amplified to a power level for transmission by a high power amplification unit 104, and is transmitted over a band of the repeater through a transmitter antenna 105.

FIG. 2 is a configuration diagram of a repeating apparatus for intermediate frequency (hereinafter, referred to as an IF)-converting and transmitting a television broadcasting signal.

Referring to FIG. 2, a receiver antenna 201 and an RF reception unit 202 receive an RF signal transmitted from a main transmitter. The signal received in the RF reception unit 202 is converted into a signal of an IF band by an IF down-conversion unit 203 and then is inputted to an IF bandpass filter 204. The IF bandpass filter 204 filters and outputs only an IF signal corresponding to a broadcasting signal of the signal of the IF band. The filtered IF signal is inputted to an RF up-conversion unit 205. The RF up-conversion unit 205 up-converts the broadcasting signal of the IF band into a broadcasting signal of an RF band for transmission, and outputs the RF signal to a high power amplification unit 206. The high power amplification unit 206 amplifies the RF signal with a predetermined amplification factor and transmits the amplified RF signal over a given channel through a transmitter antenna 207.

The above-described repeating apparatuses of FIGS. 1 and 2 do not perform demodulation, equalization and modulation processes. As shown in FIGS. 1 and 2, the repeating apparatuses, which repeat a digital television (hereinafter, referred to as “a DTV”) broadcasting signal, repeat the signal transmitted from the main transmitter as it is. That is, the repeating apparatuses of FIGS. 1 and 2 may repeat additional data, which has been inserted into the DTV broadcasting signal by the main transmitter in a baseband before modulation, without a special operation. However, since the repeating apparatuses of FIGS. 1 and 2 may not eliminate noise and a multipath signal caused by a transmission path between the main transmitter and the repeating apparatus, system noise added by a repeating apparatus system, and the like, an output signal may have characteristics inferior to those of an input signal.

FIG. 3 is a configuration diagram of a regenerative repeating apparatus that performs a modulation/demodulation process with respect to a broadcasting signal.

Referring to FIG. 3, a receiver antenna 301 and an RF reception unit 302 receive an RF signal transmitted from a main transmitter. The received RF signal is down-converted into an IF signal by an IF down-conversion unit 303. Then, the IF signal is inputted to a demodulation unit 304 and is demodulated into a transmitted broadcasting signal of a baseband. The broadcasting signal converted into the baseband signal is inputted to an equalization and FEC decoding unit 305. The equalization and FEC decoding unit 305 decodes the baseband broadcasting signal into an equalized and error corrected signal for output. The equalization and FEC decoding unit 305 may eliminate the noise, the multipath signal and the like, which are caused by the transmission path between the main transmitter and the repeating apparatus, through an equalization and demodulation process. Furthermore, the equalization and FEC decoding unit 305 may eliminate an error having occurred in a transmission path and the like.

The signal, from which the noise, the multipath signal and the like caused by the transmission path between the main transmitter and the repeating apparatus have been eliminated by the equalization and FEC decoding unit 305, is inputted to an FEC encoding unit 306. The FEC encoding unit 306 encodes the signal, from which the noise, the multipath signal and the like have been eliminated, by using an error correction code. The encoded signal is modulated into an IF band signal by a modulation unit 307 and then is inputted to an RF up-conversion unit 308. The RF up-conversion unit 308 converts the IF band signal into an RF band signal to be transmitted, and outputs the RF band signal to a high power amplification unit 309. The high power amplification unit 309 amplifies the RF signal with a predetermined amplification factor and transmits the amplified RF signal through a transmitter antenna 310.

FIG. 4 is a configuration diagram of an apparatus that equalizes and repeats a broadcasting signal.

Referring to FIG. 4, a receiver antenna 401 and an RF reception unit 402 receive an RF signal transmitted from a main transmitter, that is, only a signal of a desired band that is, a broadcasting signal. The received signal of the desired band is inputted to an IF down-conversion unit 403 and is down-converted into an IF band signal. Then, the IF band signal is inputted to a demodulation unit 404. The demodulation unit 404 demodulates the IF band signal into a baseband signal. The baseband signal is inputted to an equalization unit 405.

The equalization 405 eliminates the noise, the multipath signal and the like, which are caused by the transmission path between the main transmitter and the repeating apparatus, from the demodulated baseband signal. Then, the signal, from which the noise, the multipath signal and the like caused by the transmission path between the main transmitter and the repeating apparatus have been eliminated, is inputted to a modulation unit 406. The modulation unit 406 converts the baseband signal, from which the noise and the multipath signal have been eliminated, into an IF band signal. The IF band signal is inputted to an RF up-conversion unit 407 and is converted into an RF band signal to be transmitted. The RF band signal is inputted to a high power amplification unit 408, is amplified with a predetermined amplification factor, and then is transmitted through a transmitter antenna 409.

Since the above-described repeating apparatuses of FIGS. 3 and 4 eliminate the noise and the multipath signal caused by the transmission path between the main transmitter and the repeating apparatus, the system noise added by the repeating apparatus system, and the like, through the equalization unit or the equalization and FEC decoding unit, and perform an encoding process through the FEC encoding unit and the modulation unit, the output signal has good characteristics.

A terrestrial DTV may also transmit additional data together with a television broadcasting signal. However, the above-described repeating apparatuses of FIGS. 3 and 4 may not repeat the additional data inserted in the baseband before the modulation because only the DTV broadcasting signal remain through the equalization unit or the equalization and FEC decoding unit, and the FEC encoding unit.

### DISCLOSURE

### Technical Problem

An embodiment of the present invention is directed to a repeating apparatus and a repeating method which can repeat additional data inserted into a DTV broadcasting signal while eliminating noise and a multipath signal caused by a transmission path between a main transmitter and a repeating apparatus, system noise added by a repeating apparatus system, and the like.

Another embodiment of the present invention is directed to a repeating apparatus and a repeating method which can facilitate transmission of additional data inserted into a DTV broadcasting signal.

Another embodiment of the present invention is directed to a repeating apparatus and a repeating method which can improve reception quality of additional data inserted into a terrestrial DTV broadcasting signal.

### Technical Solution

In accordance with an embodiment of the present invention, a repeating apparatus for repeating a digital television broadcasting signal having additional data includes: a reception processing block configured to receive the additional data and the digital television broadcasting signal through a receiver antenna, down-convert the digital television broadcasting signal into an intermediate frequency signal, and demodulate the intermediate frequency signal; an equalization unit configured to eliminate noise and a multipath signal from the demodulated intermediate frequency signal of the reception processing block, and output an equalized signal, that is, an equalized symbol; an addition data extraction section configured to extract the additional data from the equalized signal outputted from the equalization unit, and output the additional data; a first adder configured to combine the equalized signal outputted from the equalization unit with output of the addition data extraction section; and a transmission processing block configured to modulate the combined signal, up-convert the modulated signal into an RF signal, amplify the RF signal to a power level for transmission, and transmit the amplified RF signal through a transmitter antenna.

In accordance with another embodiment of the present invention, a repeating apparatus for repeating a digital television broadcasting signal having additional data includes: a reception processing block configured to receive the additional data and the digital television broadcasting signal through a receiver antenna, down-convert the digital television broadcasting signal into an intermediate frequency signal, and demodulate the intermediate frequency signal; an equalization unit configured to eliminate noise and a multipath signal from the demodulated intermediate frequency signal of the reception processing block, and output an equalized signal, that is, an equalized symbol; an addition data processing unit configured to extract the additional data from the equalized signal outputted from the equalization unit, decode the additional data, and encode the additional data by using a predetermined error correction code; a first adder configured to combine the equalized signal outputted from the equalization unit with output of the addition data processing unit; and a transmission processing block configured to modulate the combined signal, up-convert the modulated signal into an RF signal, amplify the RF signal to a power level for transmission, and transmit the amplified RF signal through a transmitter antenna.

In accordance with another embodiment of the present invention, a repeating apparatus for repeating a digital television broadcasting signal having additional data includes: a reception processing block configured to receive the additional data and the digital television broadcasting signal through a receiver antenna, down-convert the digital television broadcasting signal into an intermediate frequency signal, and demodulate the intermediate frequency signal; an equalization unit configured to eliminate noise and a multipath signal from the demodulated intermediate frequency signal of the reception processing block, and output an equalized signal, that is, an equalized symbol; a digital television signal processing unit configured to decode a broadcasting signal of the equalized signal outputted from the equalization unit, and encode the broadcasting signal by using a predetermined error correction code; an additional data processing unit configured to extract the additional data from the equalized signal outputted from the equalization unit, decode the additional data, and encode the additional data by using the predetermined error correction code; a first adder configured to combine the signal outputted from the digital television signal processing unit with the output of the addition data processing unit; and a transmission processing block configured to modulate the combined signal, up-convert the modulated signal into an RF signal, amplify the RF signal to a power level for transmission, and transmit the amplified RF signal through a transmitter antenna.

In accordance with another embodiment of the present invention, a repeating method for repeating a digital television broadcasting signal having additional data includes: receiving the additional data and the digital television broadcasting signal, down-converting the digital television broadcasting signal into an intermediate frequency signal, and demodulating the intermediate frequency signal; eliminating noise and a multipath signal from the processed signal, and outputting an equalized signal, that is, an equalized symbol; extracting the additional data from the equalized signal, and outputting the additional data; combining the equalized signal with the extracted addition data; and modulating the combined signal, up-converting the modulated signal into an RF signal, amplifying the RF signal to a power level for transmission, and transmitting the amplified RF signal.

In accordance with another embodiment of the present invention, a repeating method for repeating a digital television broadcasting signal having additional data includes: receiving the additional data and the digital television broadcasting signal, down-converting the digital television broadcasting signal into an intermediate frequency signal, and demodulating the intermediate frequency signal; eliminating noise and a multipath signal from the processed signal, and outputting an equalized signal, that is, an equalized symbol; extracting the additional data from the equalized signal, decoding the additional data, and encoding the additional data by using a predetermined error correction code; combining the equalized signal with the encoded additional data; and modulating the combined signal, up-converting the modulated signal into an RF signal, amplifying the RF signal to a power level for transmission, and transmitting the amplified RF signal.

In accordance with another embodiment of the present invention, a repeating method for repeating a digital television broadcasting signal having the additional data includes: receiving the additional data and the digital television broadcasting signal, down-converting the digital television broadcasting signal into an intermediate frequency signal, and demodulating the intermediate frequency signal; eliminating noise and a multipath signal from the processed signal, and outputting an equalized signal, that is, an equalized symbol; decoding a broadcasting signal of the equalized signal, and encoding the broadcasting signal by using a predetermined error correction code; extracting the additional data from the equalized signal, decoding the additional data, and encoding the additional data by using the predetermined error correction code; combining the encoded broadcasting signal with the encoded additional data; and modulating the combined signal, up-converting the modulated signal into an RF signal, amplifying the RF signal to a power level for transmission, and transmitting the amplified RF signal.

### Advantageous Effects

In accordance with the exemplary embodiments of the present invention, an additional data extraction section or an additional data extraction and FEC decoding section, an additional data FEC encoding section and the like are added to the repeating apparatuses that repeat additional data inserted in a baseband by a transmitter, so that the quality of the transmission signal of the repeating apparatuses can be improved and simultaneously the additional data received from the transmitter can be repeated.

### DESCRIPTION OF DRAWINGS

FIG. 1 is a configuration diagram of an RF amplification repeating apparatus for repeating a television broadcasting signal.

FIG. 2 is a configuration diagram of a repeating apparatus for IF-converting and transmitting a television broadcasting signal.

FIG. 3 is a configuration diagram of a regenerative repeating apparatus that performs a modulation/demodulation process with respect to a broadcasting signal.

FIG. 4 is a configuration diagram of an apparatus that equalizes and repeats a broadcasting signal.

FIG. 5 is an internal block configuration diagram of a repeating apparatus for transmitting additional data of terrestrial DTV broadcasting in accordance with an embodiment of the present invention.

FIG. 6 is an internal block configuration diagram of a repeating apparatus for transmitting additional data of terrestrial DTV broadcasting in accordance with another embodiment of the present invention.

FIG. 7 is an internal block configuration diagram of a repeating apparatus for transmitting additional data of terrestrial DTV broadcasting in accordance with further another embodiment of the present invention.

FIG. 8 is a configuration diagram of an additional data extraction section in accordance with an embodiment of the present invention.

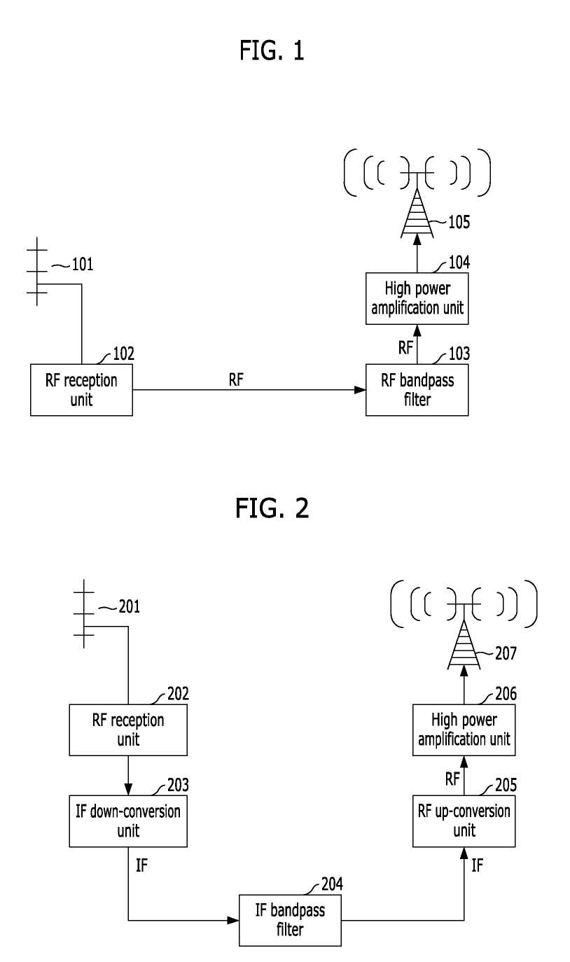

### BEST MODE

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

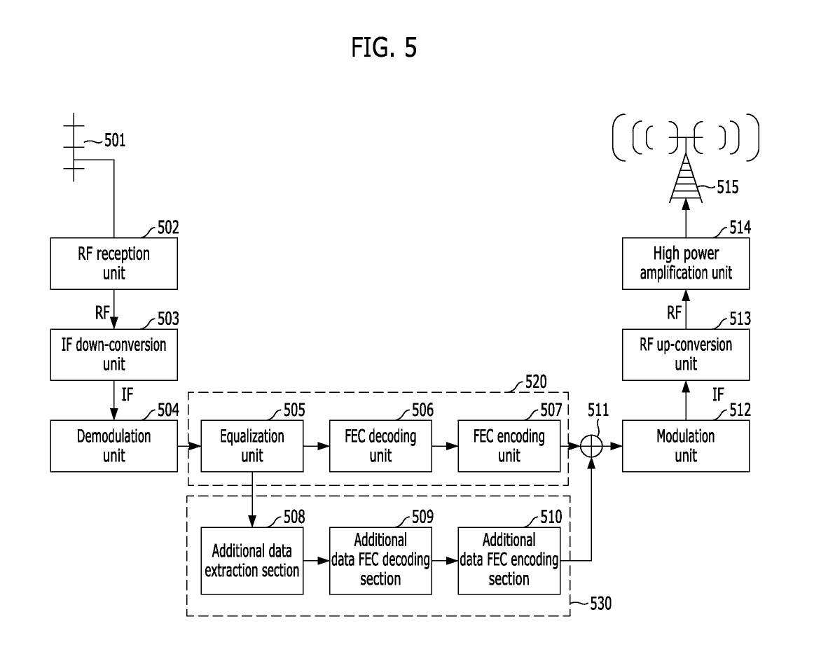

FIG. 5 is an internal block configuration diagram of a repeating apparatus for transmitting additional data of terrestrial DTV broadcasting in accordance with an embodiment of the present invention. FIG. 5 shows the internal block configuration of the repeating apparatus including the decoding section and the encoding section described in the conventional art.

Referring to FIG. 5, a receiver antenna 501 and an RF reception unit 502 are configured to receive an RF signal transmitted from a main transmitter. The received RF signal is down-converted into an IF signal by an IF down-conversion unit 503. Then, the IF signal is inputted to a demodulation unit 504 and is demodulated into a transmitted broadcasting signal of a baseband. The broadcasting signal converted into the baseband signal is inputted to an equalization unit 505. The RF reception unit 502, the IF down-conversion unit 503 and the demodulation unit 504 will be referred to as “a reception processing block”.

The equalization unit 505 is configured to eliminate noise, a multipath signal and the like, which are caused by a transmission path between the main transmitter and the repeating apparatus, from the baseband signal demodulated by the demodulation unit 504. Then, the equalization unit 505 in accordance with the embodiment of the present invention is configured to output the signal, from which the noise, the multipath signal and the like have been eliminated, to a DTV signal processing unit 520 and an additional data processing unit 530.

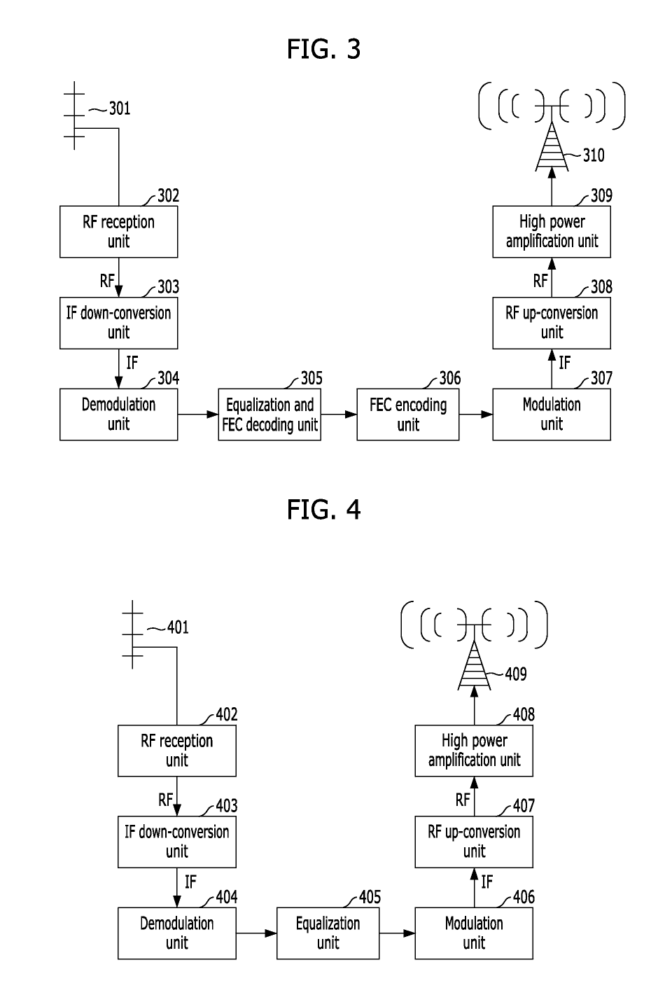

The DTV signal processing unit 520 includes an FEC decoding section 506 and an FEC encoding section 507 as with the repeating apparatus described in FIG. 3. The FEC decoding section 506 is configured to perform error correction decoding with respect to the signal from which the noise, the multipath signal and the like have been eliminated, and output a decoded signal. Then, the FEC encoding section 507 is configured to encode the output signal of the FEC decoding unit 506 by using a predetermined error correction code.

Furthermore, the additional data processing unit 530 in accordance with the embodiment of the present invention includes an additional data extraction section 508, an additional data FEC decoding section 509, and an additional data FEC encoding section 510 in order for the repeating apparatus to efficiently repeat the additional data provided through a terrestrial digital broadcasting service.

The additional data extraction section 508 is configured to extract and output the additional data inserted into the DTV broadcasting signal equalized by the equalization unit 505. Then, the additional data FEC decoding section 509 is configured to perform FEC decoding with respect to the extracted additional data by using a predetermined decoding scheme and decode the additional data into the original data. Then, the additional data FEC encoding section 510 is configured to perform error correction encoding with respect to the decoded additional data by using an encoding scheme the same as that used when the additional data has been transmitted. The encoding scheme of the digital broadcasting signal may be the same as the encoding scheme of the additional data, and vice versa. In accordance with the embodiment of the present invention, encoding schemes of each signal are not limited.

Meanwhile, an adder 511 is configured to add the signal encoded by and outputted from the DTV signal processing unit 520 to the signal encoded by and outputted from the additional data processing unit 530. That is, the adder 511 is configured to insert or combine the additional data which has been error-correction encoded by the additional data FEC encoding section 510 of the additional data processing unit 530, into (or with) the DTV broadcasting signal which has been error-correction encoded by the FEC encoding section 507 of the DTV signal processing unit 520. The combined signal is inputted to a modulation unit 512.

The modulation unit 512 is configured to achieve an IF band signal by modulating the DTV broadcasting signal having the additional data inserted thereto, and an RF up-conversion unit 513 is configured to convert the IF signal into an RF signal for output. The RF signal is variably amplified by a high power amplification unit 514 according to predetermined or radio wave environments, and then is transmitted through a transmitter antenna 515. The modulation unit 512, the RF up-conversion unit 513, and the high power amplification unit 514 will be referred to as “a transmission processing block”.

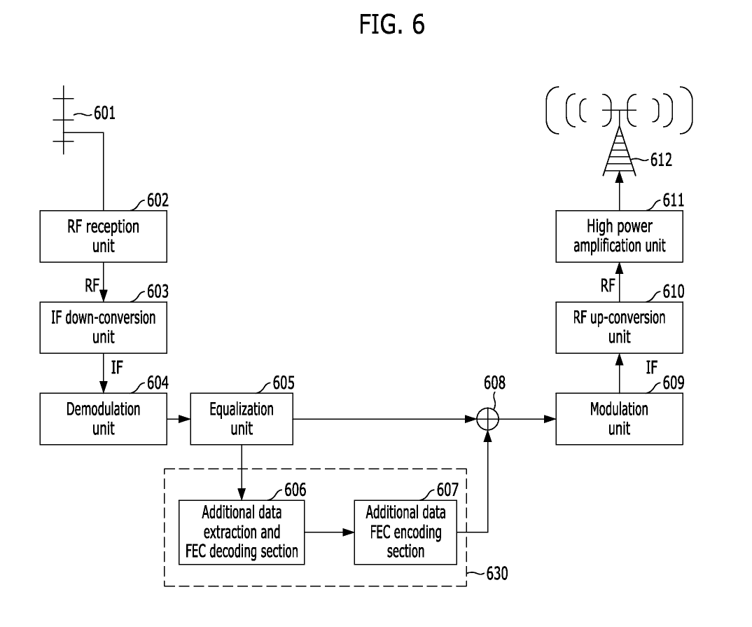

FIG. 6 is an internal block configuration diagram of a repeating apparatus for transmitting additional data of terrestrial DTV broadcasting in accordance with another embodiment of the present invention. FIG. 6 shows the internal block configuration of the equalizing repeating apparatus described in the conventional art.

Referring to FIG. 6, a receiver antenna 601 and an RF reception unit 602 are configured to receive an RF signal transmitted from a main transmitter. The received RF signal is down-converted into an IF signal by an IF down-conversion unit 603. Then, the IF signal is inputted to a demodulation unit 604 and is demodulated into a transmitted broadcasting signal of a baseband. The broadcasting signal converted into the baseband signal is inputted to an equalization unit 605. The RF reception unit 602, the IF down-conversion unit 603 and the demodulation unit 604 will be referred to as “a reception processing block”.

The equalization unit 605 is configured to eliminate noise, a multipath signal and the like, which are caused by a transmission path between the main transmitter and the repeating apparatus, from the demodulated baseband signal. Then, the equalization unit 605 in accordance with the embodiment of the present invention is configured to output the signal, from which the noise, the multipath signal and the like have been eliminated, to an adder 608 and an additional data processing unit 630.

The additional data extraction and FEC decoding section 606 is configured to extract additional data inserted into the DTV broadcasting signal equalized by the equalization unit 605, perform FEC decoding with respect to the extracted additional data by using a predetermined decoding scheme, and decode the additional data into the original data. Then, the additional data FEC encoding section 607 is configured to perform error correction encoding with respect to the decoded additional data by using an encoding scheme the same as that used when the additional data has been transmitted. The encoding scheme of the digital broadcasting signal may be the same as the encoding scheme of the additional data, and vice versa. In accordance with the embodiment of the present invention, encoding schemes of each signal are not limited.

Meanwhile, the adder 608 is configured to add the signal encoded by and outputted from the equalization unit 605 to the signal encoded by and outputted from the additional data processing unit 630. That is, the adder 608 is configured to insert or combine the additional data which has been error-correction encoded by the additional data FEC encoding section 607 of the additional data processing unit 630, into (or with) the DTV broadcasting signal from which the noise, the multipath signal and the like have been eliminated by the equalization unit 605. The combined signal is inputted to a modulation unit 609.

The modulation unit 609 is configured to achieve an IF band signal by modulating the DTV broadcasting signal having the additional data inserted thereto, and an RF up-conversion unit 610 is configured to convert the IF signal into an RF signal for output. The RF signal is variably amplified by a high power amplification unit 611 according to predetermined or radio wave environments, and then is transmitted through a transmitter antenna 612. The modulation unit 609, the RF up-conversion unit 610, and the high power amplification unit 611 will be referred to as “a transmission processing block”.

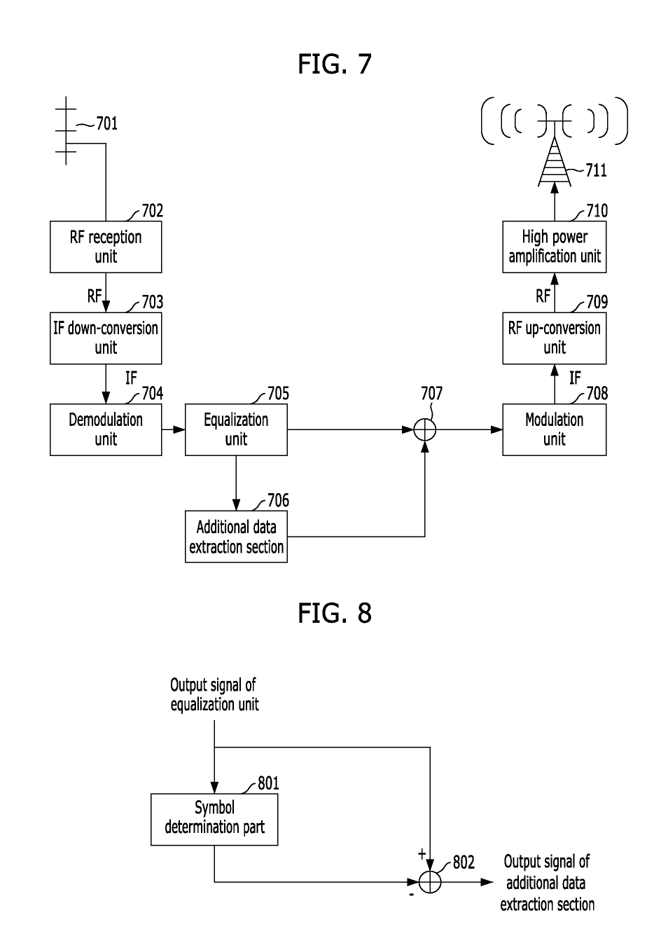

FIG. 7 is an internal block configuration diagram of a repeating apparatus for transmitting additional data of terrestrial DTV broadcasting in accordance with further another embodiment of the present invention.

Referring to FIG. 7, a receiver antenna 701 and an RF reception unit 702 are configured to receive an RF signal transmitted from a main transmitter. The received RF signal is down-converted into an IF signal by an IF down-conversion unit 703. Then, the IF signal is inputted to a demodulation unit 704 and is demodulated into a transmitted broadcasting signal of a baseband. The broadcasting signal converted into the baseband signal is inputted to an equalization unit 705. The RF reception unit 702, the IF down-conversion unit 703 and the demodulation unit 704 will be referred to as “a reception processing block”.

The equalization unit 705 is configured to eliminate noise, a multipath signal and the like, which are caused by a transmission path between the main transmitter and the repeating apparatus, from the demodulated baseband signal. Then, the equalization unit 705 in accordance with the embodiment of the present invention is configured to output the signal, from which the noise, the multipath signal and the like have been eliminated, to an adder 707 and an additional data extraction section 706.

The adder 707 is configured to add the signal encoded by and outputted from the equalization unit 705 to the signal encoded by and outputted from the additional data extraction section 706. That is, the adder 707 is configured to insert or combine data of the additional data extraction section 706, into (or with) the DTV broadcasting signal from which the noise, the multipath signal and the like have been eliminated by the equalization unit 705. The combined signal is inputted to a modulation unit 708.

The modulation unit 708 is configured to achieve an IF band signal by modulating the DTV broadcasting signal having the additional data inserted thereto, and an RF up-conversion unit 709 is configured to convert the IF signal into an RF signal for output. The RF signal is variably amplified by a high power amplification unit 710 according to predetermined or radio wave environments, and then is transmitted through a transmitter antenna 711. The modulation unit 708, the RF up-conversion unit 709, and the high power amplification unit 710 will be referred to as “a transmission processing block”.

FIG. 8 is a configuration diagram of an additional data extraction section in accordance with an embodiment of the present invention. The additional data extraction section of FIG. 8 can be applied to all the additional data extraction sections described in FIGS. 5 to 7.

Referring to FIG. 8, the additional data extraction section includes a symbol determination part 801 and an adder 802. First, the DTV broadcasting signal including the additional data, from which the noise, the multipath signal and the like have been eliminated, is outputted from the equalization units 505, 605 and 705 as described in FIGS. 5 to 7. The equalized signal is divided into two. One of them is inputted to the symbol determination part 801 and the other one of them is inputted to the adder 802.

The symbol determination part 801 is configured to perform a hard decision on the signal (that is, the symbol) inputted from the equalization unit and output a hard-decided symbol. The adder 802 is configured to calculate the difference between the symbol outputted from the equalization unit and the symbol hard-decided by the symbol determination part 801, and output the difference. The value of the difference calculated by the 802 is outputted as the additional data.

In the repeating apparatuses in accordance with the embodiments of the present invention as described above, differently from the conventional regenerative repeating apparatus and equalizing repeating apparatus, the additional data extraction section or the additional data extraction and FEC decoding section, the additional data FEC encoding section and the like are separately inserted between the demodulation unit and the modulation unit, thereby repeating the additional data while maintaining the quality of the transmission signal of the repeating apparatuses. That is, the apparatuses in accordance with the embodiments of the present invention are added to the conventional equipment, so that the apparatuses can be used even in the case of a DTV signal.

The above-described methods in accordance with the embodiments of the present invention can also be embodied as computer readable codes and stored in a computer readable recording medium including CD-ROMs, random-access memory (RAM), read-only memory (ROM), floppy disks, hard disks, optical magnetic disks and so on. Such a process may be easily construed by those skilled in the art to which the present invention pertains.

The present application contains a subject matter related to Korean Patent Application Nos. 10-2009-0094301 and 10-2010-0049581 filed in the Korean Intellectual Property Office on Oct. 5, 2009 and May 27, 2010, the entire contents of which are incorporated herein by reference.

While the present invention has been described with respect to the specific embodiments, it will be apparent to those skilled in the art that various changes and modifications may be made without departing from the spirit and scope of the invention as defined in the following claims.

1. A repeating apparatus for transmitting additional data of terrestrial digital television broadcasting, the repeating apparatus repeating a digital television broadcasting signal having the additional data, comprising:
a reception processing block configured to receive the additional data and the digital television broadcasting signal through a receiver antenna, down-convert the digital television broadcasting signal into an intermediate frequency signal, and demodulate the intermediate frequency signal;
an equalization unit configured to eliminate noise and a multipath signal from the demodulated intermediate frequency signal of the reception processing block, and output an equalized signal, that is, an equalized symbol;
an addition data extraction section configured to extract the additional data from the equalized signal outputted from the equalization unit, and output the additional data;
a first adder configured to combine the equalized signal outputted from the equalization unit with output of the addition data extraction section; and
a transmission processing block configured to modulate the combined signal, up-convert the modulated signal into an RF signal, amplify the RF signal to a power level for transmission, and transmit the amplified RF signal through a transmitter antenna.

2. The repeating apparatus of claim 1, wherein the addition data extraction section comprises:
a symbol determination part configured to perform a hard decision on the symbol outputted from the equalization unit and output a hard-decided symbol; and
a second adder configured to calculate a difference between the output of the equalization unit and the output of the symbol determination part, and extract the addition data.

3. A repeating apparatus for transmitting additional data of terrestrial digital television broadcasting, the repeating apparatus repeating a digital television broadcasting signal having the additional data, comprising:
a reception processing block configured to receive the additional data and the digital television broadcasting signal through a receiver antenna, down-convert the digital television broadcasting signal into an intermediate frequency signal, and demodulate the intermediate frequency signal;
an equalization unit configured to eliminate noise and a multipath signal from the demodulated intermediate frequency signal of the reception processing block, and output an equalized signal, that is, an equalized symbol;
an addition data processing unit configured to extract the additional data from the equalized signal outputted from the equalization unit, decode the additional data, and encode the additional data by using a predetermined error correction code;
a first adder configured to combine the equalized signal outputted from the equalization unit with output of the addition data processing unit; and
a transmission processing block configured to modulate the combined signal, up-convert the modulated signal into an RF signal, amplify the RF signal to a power level for transmission, and transmit the amplified RF signal through a transmitter antenna.

4. The repeating apparatus of claim 3, wherein the additional data processing unit comprises:
an additional data extraction section configured to extract the additional data from the equalized signal outputted from the equalization unit;
an additional data decoding section configured to decode the additional data by using the predetermined error correction code; and
an additional data encoding section configured to encode the decoded additional data by using the error correction code used for decoding the additional data.

5. The repeating apparatus of claim 4, wherein the addition data extraction section comprises:
a symbol determination part configured to perform a hard decision on the symbol outputted from the equalization unit and output a hard-decided symbol; and
a second adder configured to calculate a difference between the output of the equalization unit and the output of the symbol determination part, and extract the addition data.

6. A repeating apparatus for transmitting additional data of terrestrial digital television broadcasting, the repeating apparatus repeating a digital television broadcasting signal having the additional data, comprising:
a reception processing block configured to receive the additional data and the digital television broadcasting signal through a receiver antenna, down-convert the digital television broadcasting signal into an intermediate frequency signal, and demodulate the intermediate frequency signal;
an equalization unit configured to eliminate noise and a multipath signal from the demodulated intermediate frequency signal of the reception processing block, and output an equalized signal, that is, an equalized symbol;
a digital television signal processing unit configured to decode a broadcasting signal of the equalized signal outputted from the equalization unit, and encode the broadcasting signal by using a predetermined error correction code;
an additional data processing unit configured to extract the additional data from the equalized signal outputted from the equalization unit, decode the additional data, and encode the additional data by using the predetermined error correction code;
a first adder configured to combine the signal outputted from the digital television signal processing unit with the output of the addition data processing unit; and
a transmission processing block configured to modulate the combined signal, up-convert the modulated signal into an RF signal, amplify the RF signal to a power level for transmission, and transmit the amplified RF signal through a transmitter antenna.

7. The repeating apparatus of claim 6, wherein the additional data processing unit comprises:
an additional data extraction section configured to extract the additional data from the equalized signal outputted from the equalization unit;
an additional data decoding section configured to decode the additional data by using the predetermined error correction code; and
an additional data encoding section configured to encode the decoded additional data by using the error correction code used for decoding the additional data.

8. The repeating apparatus of claim 7, wherein the addition data extraction section comprises:
a symbol determination part configured to perform a hard decision on the symbol outputted from the equalization unit and output a hard-decided symbol; and
a second adder configured to calculate a difference between the output of the equalization unit and the output of the symbol determination part, and extract the addition data.

9. The repeating apparatus of claim 6, wherein the digital television signal processing unit comprises:
a digital television signal decoding section configured to decode the equalized signal outputted from the equalization unit by using a decoding scheme of a digital television broadcasting signal; and
a digital television signal encoding section configured to encode the decoded digital television signal by using an encoding scheme of the digital television signal.

10. A repeating method for transmitting additional data of terrestrial digital television broadcasting, the repeating method repeating a digital television broadcasting signal having the additional data, comprising:
receiving the additional data and the digital television broadcasting signal, down-converting the digital television broadcasting signal into an intermediate frequency signal, and demodulating the intermediate frequency signal;
eliminating noise and a multipath signal from the processed signal, and outputting an equalized signal, that is, an equalized symbol;
extracting the additional data from the equalized signal, and outputting the additional data;
combining the equalized signal with the extracted addition data; and
modulating the combined signal, up-converting the modulated signal into an RF signal, amplifying the RF signal to a power level for transmission, and transmitting the amplified RF signal.

11. The repeating method of claim 10, wherein said extracting the additional data comprises:
performing a hard decision on the equalized symbol and outputting a hard-decided symbol; and
calculating a difference between the equalized output and the hard-decided output, and extracting the addition data.

12. A repeating method for transmitting additional data of terrestrial digital television broadcasting, the repeating method repeating a digital television broadcasting signal having the additional data, comprising:
receiving the additional data and the digital television broadcasting signal, down-converting the digital television broadcasting signal into an intermediate frequency signal, and demodulating the intermediate frequency signal;
eliminating noise and a multipath signal from the processed signal, and outputting an equalized signal, that is, an equalized symbol;
extracting the additional data from the equalized signal, decoding the additional data, and encoding the additional data by using a predetermined error correction code;
combining the equalized signal with the encoded additional data; and
modulating the combined signal, up-converting the modulated signal into an RF signal, amplifying the RF signal to a power level for transmission, and transmitting the amplified RF signal.

13. The repeating method of claim 12, wherein said extracting the additional data from the equalized signal, decoding the additional data, and encoding the additional data by using the predetermined error correction code comprises:
extracting the additional data from the equalized signal;
decoding the extracted additional data by using the predetermined error correction code; and
encoding the decoded additional data by using the error correction code used for decoding the additional data.

14. The repeating method of claim 13, wherein said extracting the additional data comprises:
performing a hard decision on the equalized symbol outputted from the equalization unit and outputting a hard-decided symbol; and
calculating a difference between the equalized output and the hard-decided output, and extracting the addition data.

15. A repeating method for transmitting additional data of terrestrial digital television broadcasting, the repeating method repeating a digital television broadcasting signal having the additional data, comprising:
receiving the additional data and the digital television broadcasting signal, down-converting the digital television broadcasting signal into an intermediate frequency signal, and demodulating the intermediate frequency signal;
eliminating noise and a multipath signal from the processed signal, and outputting an equalized signal, that is, an equalized symbol;
decoding a broadcasting signal of the equalized signal, and encoding the broadcasting signal by using a predetermined error correction code;
extracting the additional data from the equalized signal, decoding the additional data, and encoding the additional data by using the predetermined error correction code;
combining the encoded broadcasting signal with the encoded additional data; and
modulating the combined signal, up-converting the modulated signal into an RF signal, amplifying the RF signal to a power level for transmission, and transmitting the amplified RF signal.

16. The repeating method of claim 15, wherein said extracting the additional data from the equalized signal, decoding the additional data, and encoding the additional data by using the predetermined error correction code comprises:
extracting the additional data from the equalized signal;
decoding the extracted additional data by using the predetermined error correction code; and
encoding the decoded additional data by using the error correction code used for decoding the additional data.

17. The repeating method of claim 16, wherein said extracting the additional data comprises:
performing a hard decision on the equalized symbol outputted from the equalization unit and outputting a hard-decided symbol; and
calculating a difference between the equalized output and the hard-decided output, and extracting the addition data.

18. The repeating method of claim 15, wherein said decoding the broadcasting signal of the equalized signal, and encoding the broadcasting signal by using the predetermined error correction code comprises:
decoding the equalized signal by using a decoding scheme of a digital television broadcasting signal; and
encoding the decoded digital television signal by using an encoding scheme of the digital television signal.
